(19) United States
(12) Patent Application Publication
(10) Pub. No.: US 2016/0125816 A1
(43) Pub. Date: May 5, 2016

(54) DISPLAY APPARATUS

(71) Applicant: Samsung Display Co., Ltd., Yongin-City (KR)

(72) Inventors: Jongho Chong, Yongin-City (KR); Seungbae Lee, Yongin-City (KR)

(21) Appl. No.: 14/686,703

(22) Filed: Apr. 14, 2015

(30) Foreign Application Priority Data
Nov. 3, 2014 (KR) 10-2014-0151212

(51) Int. Cl. G09G 3/34

(52) U.S. Cl. CPC G09G 3/3406; G09G 2320/0626

(57) ABSTRACT

A display apparatus includes: a display unit including a plurality of pixels; a connection part on the display unit; a plurality of shape-variable parts on the connection part and configured to deform according to a physical quantity applied thereto; and adjustors configured to vary the physical quantity applied to the shape-variable parts to control refraction of light by the shape-variable parts while the light emitted from the pixels passes therethrough.

### CROSS-REFERENCE TO RELATED APPLICATION

This application claims priority to and the benefit of Korean Patent Application No. 10-2014-0151212, filed on Nov. 3, 2014 in the Korean Intellectual Property Office, the disclosure of which is incorporated herein in its entirety by reference.

### BACKGROUND

1. Field

One or more exemplary embodiments of the present invention relate to a display apparatus.

2. Description of the Related Art

Viewing angles of display apparatuses are determined by the light emitting structure of pixels therein. It may be desirable to adjust the viewing angle of a display apparatus according to content to be displayed. In addition, it may be desirable to adjust the brightness of a display apparatus according to the environment in which the display apparatus is used.

### SUMMARY

One or more exemplary embodiments of the present invention include a display apparatus which may adjust a viewing angle of a display unit therein.

One or more exemplary embodiments of the present invention include a display apparatus which may adjust brightness of a display unit therein.

Additional aspects will, be set forth in part in the description which follows and, in part, will be apparent from the description, or may be learned by practice of the presented embodiments.

According to one or more exemplary embodiments of the present invention, a display apparatus includes: a display unit including a plurality of pixels; a connection part on the display unit; a plurality of shape-variable parts on the connection part and configured to deform according to a physical quantity applied thereto; and a plurality of adjustors configured to vary the physical quantity applied to the shape-variable parts to control an amount in which the shape-variable parts refract light emitted from the pixels.

The shape-variable parts may be on the connection part at positions corresponding to positions of the pixels.

Each of the shape-variable parts may be configured to deform to be flat, convex, or concave according to a value of the physical quantity.

When the shape-variable parts are convex, the light emitted from the pixels may be condensed by the shape-variable parts.

When the shape-variable parts are concave, the light emitted from the pixels may be diverged by the shape-variable parts.

The adjustors may include temperature adjustors configured to adjust temperatures of the shape-variable parts to deform the shape-variable parts.

The temperature adjustors may each include: heating elements configured to apply heat to the shape-variable parts or to the connection part; and current supplies coupled to the heating elements and configured to supply current to the heating elements.

Each of the shape-variable parts may include a conductor, and the adjustors may include current adjustors configured to control an amount of current flowing through the conductors of the shape-variable parts.

Each of the shape-variable parts may include two electrodes, and in each of the shape-variable parts, the current adjustor may be configured to control an electric potential between the two electrodes to adjust an amount of current flowing through the conductor between the two electrodes.

Each of the conductors may include carbon nanotubes.

The display apparatus may further include: a controller configured to output control signals and image data; a gate driver configured to output a scan signal based on the control signals; and a source driver configured to output a data signal based on the image data in synchronization with the scan signal, wherein the display unit may be configured to output the data signal to the pixels in synchronization with the scan signal.

According to one or more exemplary embodiments of the present invention, a display apparatus includes: a display unit including a plurality of pixels; a shape-variable part on the display unit and configured to deform according to a physical quantity applied thereto; and an adjustor configured to vary the physical quantity applied to the shape-variable part to control an amount by which the shape-variable part refracts light emitted from the pixels.

A plurality of convex regions and/or a plurality of concave regions may be formed on a surface of the shape-variable part according to values of the physical quantity.

The convex regions and/or the concave regions may be formed at positions corresponding to positions of the pixels.

The light emitted from the pixels may be condensed by the convex regions or may be diverged by the concave regions.

The adjustor may include a temperature adjustor configured to adjust a temperature of the shape-variable part to change a shape of the shape-variable part.

The temperature adjustor may include: a heating element configured to apply heat to the shape-variable part; and a current supply coupled to the heating element and configured to supply a current to the heating element.

The shape-variable part may include a conductor, and the adjustor may include a current adjustor configured to control an amount of current flowing through the conductor of the shape-variable part.

The shape-variable part may include first and second electrodes, the current adjustor may be configured to control an electric potential between the first and second electrodes to control an amount of current flowing through the conductor between the first and second electrodes, and the conductor may include carbon nanotubes.

The display apparatus may further include: a controller configured to output control signals and image data; a gate driver configured to output a scan signal based on the control signals; and a source driver configured to output a data signal based on the image data in synchronization with the scan signal, wherein the display unit may be configured to output the data signal to the pixels in synchronization with the scan signal.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a schematic view illustrating a display apparatus according to an exemplary embodiment of the present invention;

FIGS. 2A and 2B are schematic views illustrating light refracted by shape-variable parts;

FIG. 3 is a schematic view illustrating an exemplary embodiment of the present invention capable of heating shape-variable parts;

FIG. 4 is a schematic view illustrating an exemplary embodiment of the present invention capable of applying current to shape-variable parts;

FIG. 5 is a schematic view illustrating a display apparatus according to another exemplary embodiment of the present invention; and

FIG. 6 is a schematic view illustrating a display apparatus according to another exemplary embodiment of the present invention.

### DETAILED DESCRIPTION

Reference will now be made in detail to exemplary embodiments of the present invention, examples of which are illustrated in the accompanying drawings. Features and characteristics of the exemplary embodiments, and implementation methods thereof, will be clarified through the following descriptions given with reference to the accompanying drawings. In this regard, the exemplary embodiments may have different forms and should not be construed as being limited to the descriptions set forth herein. As used herein, the term “and/or” includes any and all combinations of one or more of the associated listed items.

Hereinafter, exemplary embodiments of the present invention will be described in detail with reference to the accompanying drawings. In the drawings, like reference numerals denote like elements, and overlapping descriptions thereof may be omitted.

It will be understood that although the terms “first”, “second”, etc. may be used herein to describe various components, these components should not be limited by these terms. These terms are only used to distinguish one component from another. As used herein, the singular forms “a” and “an” are intended to include the plural forms as well, unless the context clearly indicates otherwise. It will be further understood that the terms “includes”, “including”, “comprises”, and/or “comprising” used herein specify the presence of stated features or components but do not preclude the presence or addition of one or more other features or components.

It will be understood that when an element or layer is referred to as being “on”, “connected to”, or “coupled to” another element or layer, it may be directly on, connected, or coupled to the other element or layer or one or more intervening elements or layers may also be present. When an element is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. Further, the use of “may” when describing embodiments of the present invention relates to “one or more embodiments of the present invention”. Expression, such as “at least one of,” when preceding a list of elements, modify the entire list of elements and do not modify the individual elements of the list. Also, the term “exemplary” is intended to refer to an example or illustration.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly. As used herein, the terms “use,” “using,” and “used” may be considered synonymous with the terms “utilize,” “utilizing,” and “utilized,” respectively.

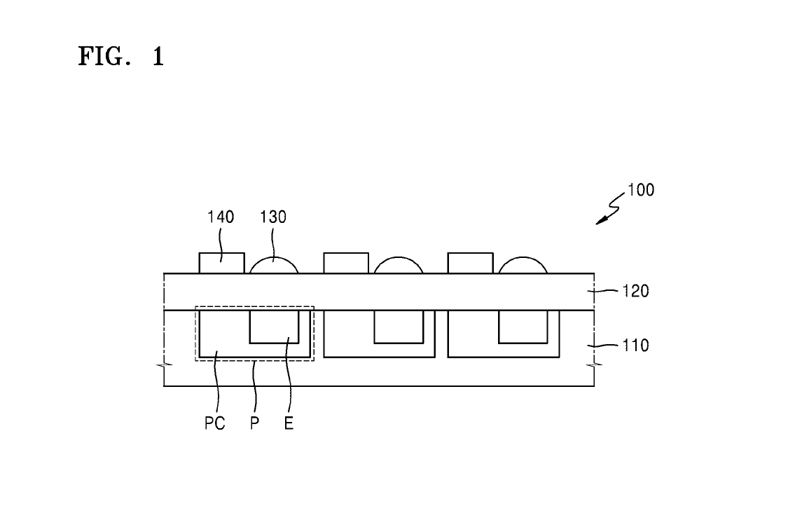

FIG. 1 is a schematic view illustrating a display apparatus 100 according to an exemplary embodiment of the present invention.

Referring to FIG. 1, the display apparatus 100 of one exemplary embodiment includes a display unit 110, a connection part 120, a plurality of shape-variable parts 130, and adjusting units 140 (e.g., adjustors).

The display apparatus 100 may be a flat display apparatus, such as an organic light emitting diode (OLED) display, a thin film transistor liquid crystal display (TFT-LCD), a plasma display panel (PDP), or a light emitting diode (LED) display. However, the display apparatus 100 is not limited thereto. That is, the display apparatus 100 may be any suitable display apparatus capable of receiving image signals and outputting images corresponding to the image signals. The display apparatus 100 may be part of an electronic apparatus, such as a smartphone, a personal computer (PC), a laptop PC, a monitor, or a TV, or may be an image display component of such an electronic apparatus. The following description will be presented under the assumption that the display apparatus 100 is an OLED display.

The display unit 110 may display images. The display unit 110 may be a flat display panel, such as an OLED panel or a liquid crystal (LC) panel. However, the exemplary embodiments of the present disclosure are not limited thereto. The display unit 110 may include a plurality of pixels P. In FIG. 1, the display unit 110 is illustrated as including only three pixels P. However, exemplary embodiments of the present invention are not limited thereto. For example, the display unit 110 may include a plurality of pixels P arranged in a lattice.

The pixels P may include a plurality of sub-pixels for displaying a plurality of colors and, thus, expressing various color images. In embodiments of the present invention, a pixel P usually refers to a sub-pixel. However, exemplary embodiments of the present invention are not limited thereto. For example, a pixel P may refer to a unit pixel including a plurality of sub-pixels. That is, in embodiments of the present invention, when a pixel P is stated, it could be construed as a sub-pixel or as sub-pixels constituting a unit pixel.

Each pixel P may include a light emitting device E and a pixel circuit PC coupled to (e.g., connected to) the light emitting device E. The light emitting device E may receive a driving current from the pixel circuit PC and emit light. The light emitting device E may emit light having a color. For example, the light emitting device E may emit light having one of red, blue, green, and white colors. However, exemplary embodiments of the present invention are not limited thereto. For example, the light emitting device E may emit light having a color other than red, blue, green, and white. The pixel circuit PC may include one or more transistors. The pixel circuit PC may include one or more capacitors.

In FIG. 1, boundaries of the pixels P in the display unit 110 are clearly illustrated. However, the boundaries are conceptual boundaries. In the display apparatus 100, the boundaries between the display unit 110 and the pixels P may not be clear, and, in the display unit 110 including a plurality of circuits, a region including a light emitting device E and a pixel circuit PC causing the light emitting device E to emit light by applying a driving current to the light emitting device E may be a pixel P.

The connection part 120 may be disposed on the display unit 110. The connection part 120 may be transparent and, thus, may transmit all kinds of light, such as red, blue, green, and white light. Therefore, the connection part 120 may transmit light emitted from the light emitting devices E without absorbing the light. The connection part 120 may be formed of a material, such as a transparent plastic material or transparent glass. However, the connection part 120 is not limited thereto.

The shape-variable parts 130 may be disposed on the connection part 120. The shape-variable parts 130 may be disposed on the connection part 120 at positions corresponding to positions of the pixels P. For example, the shape-variable parts 130 may be disposed on the connection part 120 at positions respectively corresponding to the light emitting devices E of the pixels P. As a result, light emitted from the light emitting devices E may be refracted while passing through the shape-variable parts 130.

Each of the shape-variable parts 130 may be deformed by a physical quantity applied thereto. In the present embodiment, the term “physical quantity” refers to a measurable quantity which is a subject of physics. Examples of the physical quantity include temperature, capacitance, brightness, sound intensity or pitch, current, pressure, and acidity. However, the physical quantity is not limited thereto. Each of the shape-variable parts 130 may be deformed to have a flat, convex, or concave shape according to a physical quantity applied thereto. For example, the shape-variable parts 130 may be deformed to have different convex shapes according to values of a physical quantity applied thereto. For example, the shape-variable parts 130 may be deformed to have different concave shapes according to values of a physical quantity applied thereto.

The shape-variable parts 130 may be formed of a shape memory polymer. However, the shape-variable parts 130 are not limited thereto. If the same value of a physical quantity is applied to the shape-variable parts 130, each of the shape-variable parts 130 may be deformed to have the same or substantially the same shape. For example, during a first time period, the shape-variable parts 130 may have a first shape when the temperature of the shape-variable parts 130 is 50° C. and a second shape when the temperature of the shape-variable parts 130 is 70° C. In this embodiment, during a second time period different from the first time period, the shape-variable parts 130 may have the first shape when the temperature of the shape-variable parts 130 is 50° C. and the second shape when the temperature of the shape-variable parts 130 is 70° C.

The shape-variable parts 130 may be deformed in response to a variation of a first physical quantity, independent of a variation of a second physical quantity. For example, the shapes of the shape-variable parts 130 may be varied according to variations in the amount of current flowing therethrough but may not be varied even though the temperatures of the shape-variable parts 130 varies.

The adjusting units 140 may vary a physical quantity applied to the shape-variable parts 130. In FIG. 1, the adjusting units 140 are disposed on the connection part 120. However, exemplary embodiments of the present invention are not limited thereto. For example, the adjusting units 140 may be disposed between the display unit 110 and the connection part 120. In FIG. 1, the adjusting units 140 are disposed close to (e.g., near) the respective shape-variable parts 130. However, exemplary embodiments of the present invention are not limited thereto. For example, the adjusting units 140 may be provided as a single continuous layer disposed between the display unit 110 and the connection part 120 or on the connection part 120.

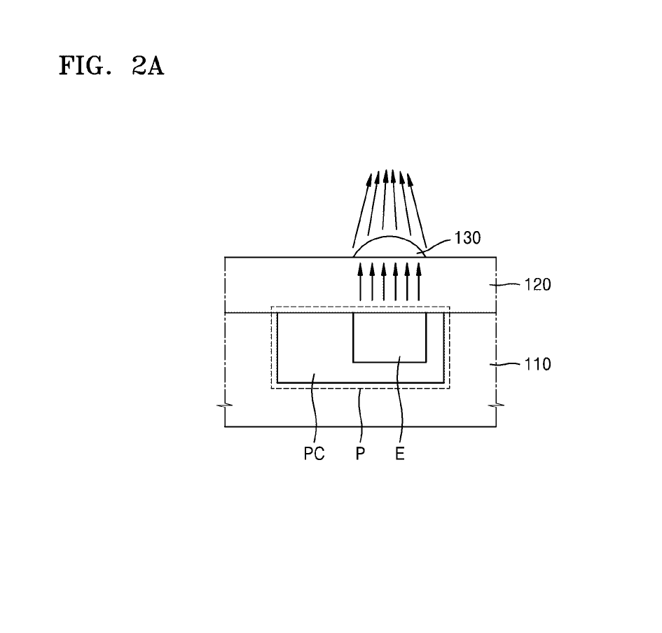

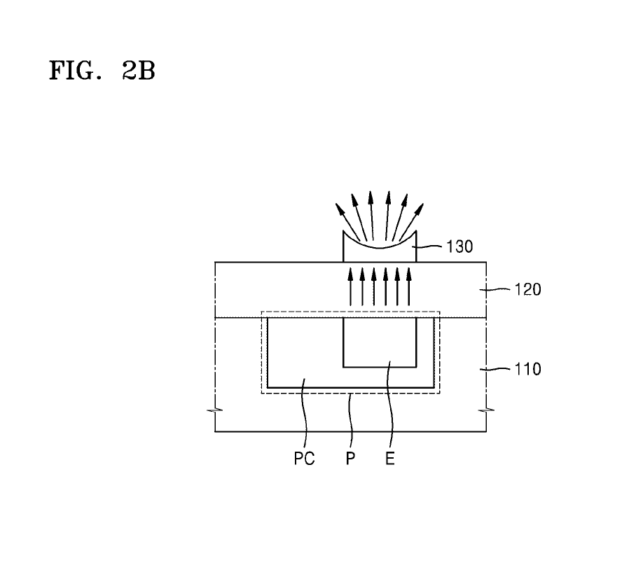

FIGS. 2A and 2B are schematic views illustrating light refracted by the shape-variable parts 130 (only one of which is shown).

Referring to FIGS. 2A and 2B, in one exemplary embodiment, light emitted from the light emitting devices E may pass through the connection part 120. Then, the light may be refracted while passing through the shape-variable parts 130.

When the shape-variable parts 130 have convex shapes, light emitted from the pixels P may condense (e.g., converge) while passing through the shape-variable parts 130. For example, when light is emitted from the light emitting devices E of the respective pixels P, the angle of the light may be determined by physical structures of the light emitting devices E and the pixels P. Then, the light emitted from the light emitting devices E may pass through the connection part 120. After passing through the connection part 120, the light may pass through the shape-variable parts 130. At this time, when the shape-variable parts 130 have convex shapes as shown in FIG. 2A, light incident on the shape-variable parts 130 may condense after passing though the shape-variable parts 130. For example, light emitted from the light emitting devices E may have a first angle and then may have a second angle after passing through the shape-variable parts 130. In this embodiment, the second angle may be wider than the first angle.

All of the shape-variable parts 130 of the display apparatus 100 may have the same convex shape or different convex shapes. For example, when the same value of a physical quantity is applied to all of the shape-variable parts 130 of the display apparatus 100, all of the shape-variable parts 130 may have the same convex shape. In this embodiment, light emitted from the light emitting devices E of all of the pixels P may be refracted by the same degree. In another embodiment, when different values of a physical quantity are applied to first and second shape-variable parts of the display apparatus 100, the first and second shape-variable parts may be deformed to have different convex shapes. In this embodiment, the refraction angle of light emitted from the light emitting device E and passing through the first shape-variable part may be different from the refraction angle of light emitted from a light emitting device E and passing through the second shape-variable part.

When the shape-variable parts 130 have concave shapes, light emitted from the pixels P may diverge while passing through the shape-variable parts 130. For example, when light is emitted from the light emitting devices E of the respective pixels P, the angle of the light may be determined by the physical structures of the light emitting devices E and the pixels P. Then, the light emitted from the light emitting devices E may pass through the connection part 120. After passing through the connection part 120, the light may pass through the shape-variable parts 130. At this time, when the shape-variable parts 130 have concave shapes as shown in FIG. 2B, light incident on the shape-variable parts 130 may diverge while passing though the shape-variable parts 130. For example, light emitted from the light emitting devices E may have a third angle and then may have a fourth angle after passing through the shape-variable parts 130. In this embodiment, the fourth angle may be narrower than the third angle.

All of the shape-variable parts 130 of the display apparatus 100 may have the same concave shape or different concave shapes. For example, when the same value of a physical quantity is applied to all of the shape-variable parts 130 of the display apparatus 100, all of the shape-variable parts 130 may be deformed into the same concave shape. In this embodiment, light emitted from the light emitting devices E of all of the pixels P may be refracted to the same degree. In another embodiment, when different values of a physical quantity are applied to first and second shape-variable parts of the display apparatus 100, the first and second shape-variable parts may be deformed into different concave shapes. In this embodiment, the refraction angle of light emitted from a light emitting device E and passing through the first shape-variable part may be different from the refraction angle of light emitted from a light emitting device E and passing through the second shape-variable part.

In FIGS. 2A and 2B, light emitted from the light emitting devices E is illustrated using parallel lines. However, exemplary embodiments of the present invention are not limited thereto. That is, light may be emitted at various angles according to the physical structures of the light emitting devices E and the pixels P.

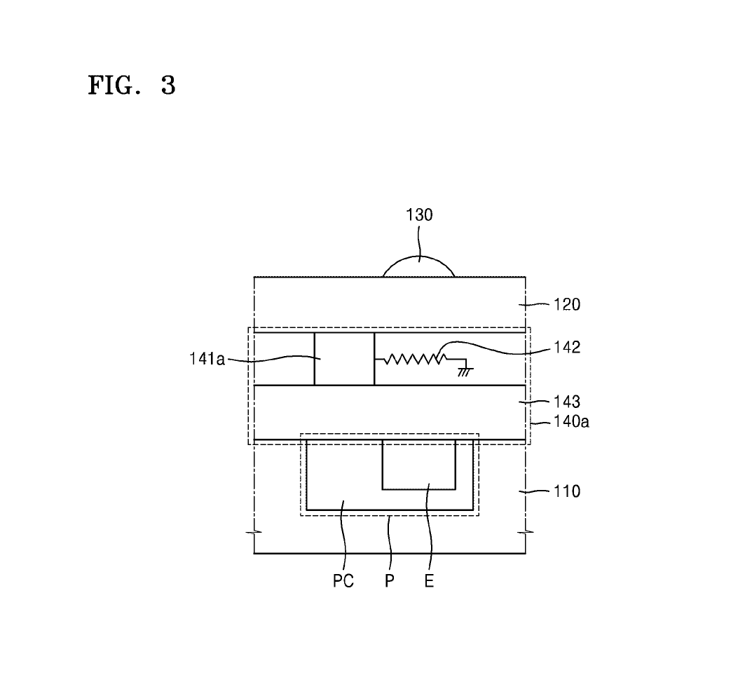

FIG. 3 is a schematic view illustrating an exemplary embodiment of the present invention capable of heating the shape-variable parts 130 (only one of which is shown).

Referring to FIG. 3, the display apparatus 100 of one exemplary embodiment may include temperature adjusting units 140a (e.g., temperature adjustors) disposed on the display unit 110. The temperature adjusting units 140a may include first current supply units 141a (e.g., first current supplies), heating elements 142, and an intermediate substrate 143. The adjusting units 140 may include the temperature adjusting units 140a or may be the temperature adjusting units 140a. The following will be presented under the assumption that the adjusting units 140 are the temperature adjusting units 140a.

The first current supply units 141a may supply currents to the heating elements 142. The first current supply units 141a may control the amount of current that is supplied to the respective heating elements 142. Each of the first current supply units 141a may include at least one transistor. Sources or drains of the transistors of the first current supply units 141a may be electrically coupled to (e.g., electrically connected to) the heating elements 142. In embodiments of the present invention, the first current supply units 141a may be referred to as current supply units.

When current is applied to each of the heating elements 142, the heating elements 142 may generate heat. When the heating elements 142 generate heat, the temperature of the connection part 120 or the shape-variable parts 130 may increase. When the heating elements 142 generate less heat or no heat (e.g., when no current is applied to the heating elements 142), the temperature of the connection part 120 or the shape-variable parts 130 may decrease. When the temperature of the connection part 120 is varied, the temperature of the shape-variable parts 130 disposed on the connection part 120 may also be varied. That is, the temperature of the shape-variable parts 130 may be indirectly varied. When the temperatures of the shape-variable parts 130 are varied, the shapes of the shape-variable parts 130 may be varied. As a result, light passing through the shape-variable parts 130 may be refracted. The heating elements 142 may be coils wound in a certain direction. However, the heating elements 142 are not limited thereto.

The intermediate substrate 143 may be disposed between the display unit 110 and a region in which the first current supply units 141a and the heating elements 142 are arranged. Owing to the intermediate substrate 143, the display unit 110 may be separated from the first current supply units 141a by a constant distance. The intermediate substrate 143 may prevent current from flowing from the first current supply units 141a or the heating elements 142 to the display unit 110. Furthermore, owing to the intermediate substrate 143, the temperature of the display unit 110 may be less affected by heat generated by the heating elements 142. The intermediate substrate 143 may be transparent and, thus, may transmit all kinds of light such as red, blue, green, and white light. Therefore, the intermediate substrate 143 may transmit light emitted from the light emitting devices E without absorbing the light. The intermediate substrate 143 may be formed of a material, such as a transparent plastic material or transparent glass. However, the intermediate substrate 143 is not limited thereto.

In FIG. 3, the temperature adjusting units 140a are disposed between the display unit 110 and the connection part 120. However, exemplary embodiments of the present invention are not limited thereto. For example, the temperature adjusting units 140a may be disposed at various positions as long as the temperature adjusting units 140a may vary the temperature of the connection part 120 or the shape-variable parts 130.

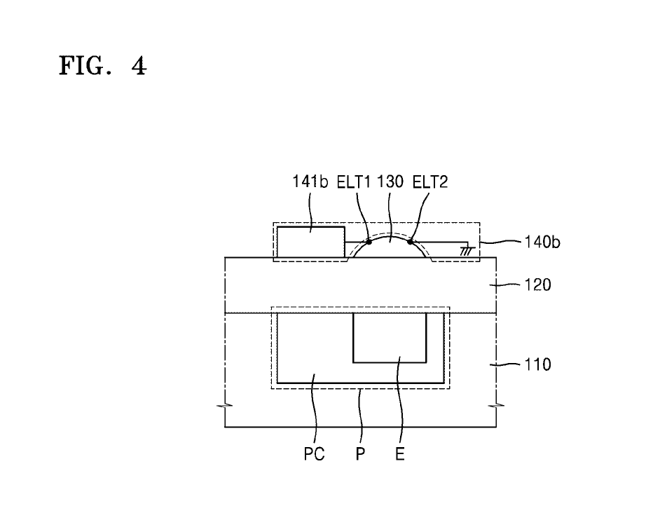

FIG. 4 is a schematic view illustrating an exemplary embodiment of the present invention capable of applying current to the shape-variable parts 130 (only one of which is shown).

Referring to FIG. 4, the display apparatus 100 of one exemplary embodiment may include current adjusting units 140b (e.g., current adjustors) disposed on the connection part 120. The current adjusting units 140b may include second current supply units 141b (e.g., second current supplies). The adjusting units 140 may include the current adjusting units 140b or may be the current adjusting units 140b. The following will be presented under the assumption that the adjusting units 140 are the current adjusting units 140b.

Each of the shape-variable parts 130 may include a conductor. Each of the shape-variable parts 130 may include an electric conductor as a constituent element or may be an electrically conductor itself. The conductors of the shape-variable parts 130 may include carbon nanotubes. However, exemplary embodiments of the present invention are not limited thereto. For example, the conductors may include any material capable of conducting current. Each of the shape-variable parts 130 may include two electrodes. For example, as shown in FIG. 4, each of the shape-variable parts 130 may include a first electrode ELT1 and a second electrode ELT2. The first electrodes ELT1 may be coupled to the second current supply units 141b. The second electrodes ELT2 may be grounded.

The second current supply units 141b output current to each of the shape-variable parts 130. For example, as shown in FIG. 4, current may be output to each of the shape-variable parts 130 through the first electrodes ELT1. The second current supply units 141b may control the amount of current that is supplied to the shape-variable parts 130. Each of the second current supply units 141b may include at least one transistor. Sources or drains of the transistors of the second current supply units 141b may be electrically coupled to the shape-variable parts 130.

In FIG. 4, the current adjusting units 140b are disposed on the connection part 120. However, exemplary embodiments of the present invention are not limited thereto. For example, the current adjusting units 140b may be disposed at various positions as long as the current adjusting units 140b may supply currents to the shape-variable parts 130 while controlling the currents. In FIG. 4, the shape-variable parts 130 and the current adjusting units 140b are disposed in an uppermost layer. However, exemplary embodiments of the present invention are not limited thereto. For example, an upper substrate may be disposed on the shape-variable parts 130 and the current adjusting units 140b. The upper substrate may be formed of a material such as a transparent plastic material or transparent glass. However, the upper substrate is not limited thereto.

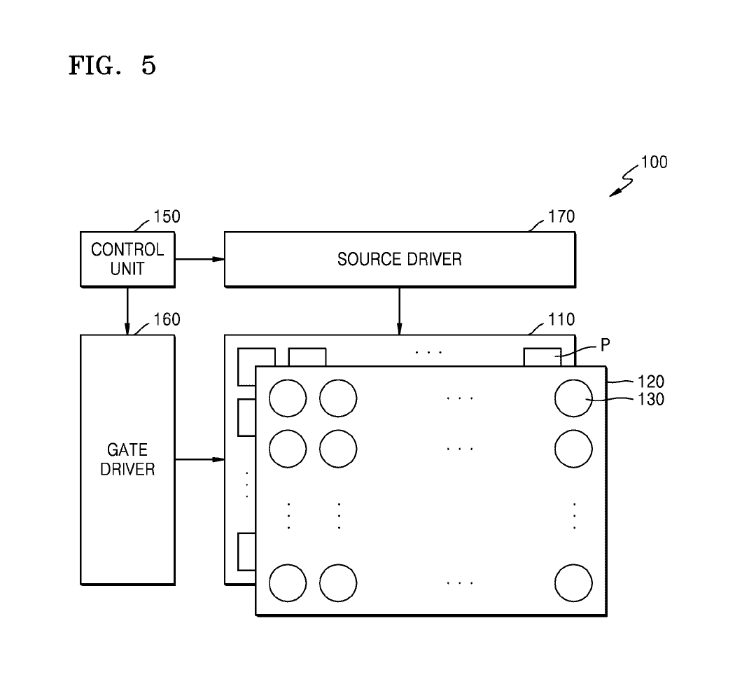

FIG. 5 is a schematic view illustrating a display apparatus 100 according to another exemplary embodiment of the present invention.

Referring to FIG. 5, the display apparatus 100 of the current exemplary embodiment includes a display unit 110, the connection part 120, the plurality of shape-variable parts 130, a control unit 150 (e.g., a controller), a gate driver 160, and a source driver 170. In the current exemplary embodiment illustrated in FIG. 5, some elements are added compared to the previous exemplary embodiment described with reference to FIG. 1. In the following description, those elements will be mainly described.

The control unit 150 may output a first control signal, a second control signal, and image data. The first control signal may generate a scan signal. The second control signal may be output a voltage corresponding to the image data in synchronization with the scan signal. The control unit 150 may output the first signal to the gate driver 160. The control unit 150 may output the image data and the second signal to the source driver 170.

The gate driver 160 may output a scan signal to the display unit 110. The gate driver 160 may be coupled to the display unit 110 through a plurality of scan lines and may output the scan signal to the display unit 110 through the plurality of scan lines.

The source driver 170 may output a data signal to the display unit 110 in synchronization with the scan signal. The source driver 170 may output the data signal to the display unit 110 based on the image data. The source driver 170 may be coupled to the display unit 110 through a plurality of data lines and may output the data signal to the display unit 110 through the plurality of data lines.

The scan lines coupled to the gate driver 160 may be arranged on the display unit 110. The data lines coupled to the source driver 170 may be arranged on the display unit 110. The display unit 110 may include the plurality of pixels P. The pixels P may be disposed at crossing points between the scan lines and the data lines. The shape-variable parts 130 may be disposed on the connection part 120. The connection part 120 may be disposed on the display unit 110. The shape-variable parts 130 may be disposed on the connection part 120 at positions corresponding to positions of the pixels P arranged in the display unit 110.

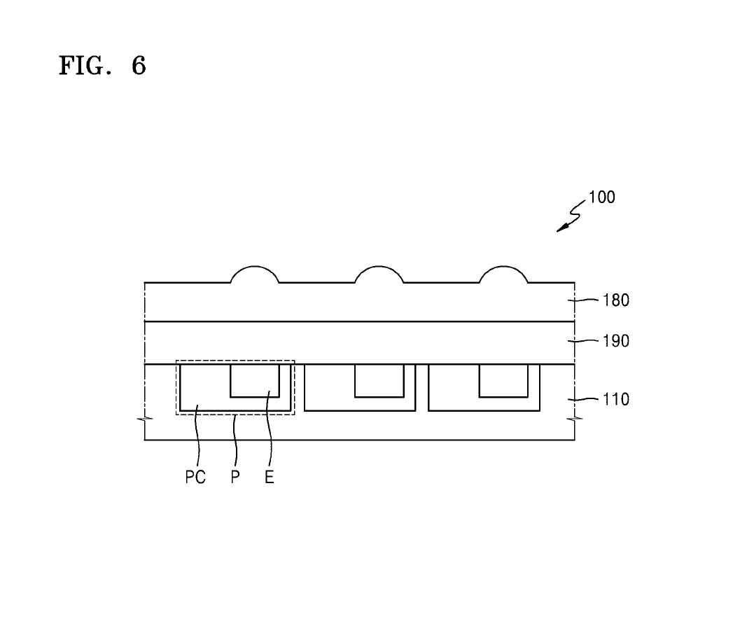

FIG. 6 is a schematic view illustrating a display apparatus 100 to another exemplary embodiment of the present invention.

Referring to FIG. 6, a display apparatus 100 of the current exemplary embodiment includes a display unit 110, a shape-variable part 180, and an adjusting unit 190. In the current exemplary embodiment illustrated in FIG. 6, some elements are changed compared to the previous exemplary embodiment described with reference to FIG. 1. In the following description, those elements will be mainly described.

The shape-variable part 180 may be disposed on the display unit 110. A plurality of convex or concave regions may be formed on a surface of the shape-variable part 180 according to values of a physical quantity applied to the shape-variable part 180 (e.g., applied to a surface of the shape-variable part 180). The positions of the convex or concave regions on the surface of the shape-variable part 180 may correspond to the positions of a plurality of pixels P. For example, the convex or concave regions may be formed on the surface of the shape-variable part 180 at positions respectively corresponding to positions of light emitting devices E of the pixels P. As a result, light emitted from the light emitting devices E may be refracted while passing through the shape-variable part 180.

The shape-variable part 180 may be formed of a shape memory polymer. However, the shape-variable part 180 is not limited thereto. When the same value of a physical quantity is applied to the shape-variable part 180, regions having the same shape may be formed on the shape-variable part 180. For example, during a first time period, the shape-variable part 180 may have a first shape when the temperature of the shape-variable part 180 is 50° C. and a second shape when the temperature of the shape-variable part 180 is 70° C. In this embodiment, during a second time period different from the first time period, the shape-variable part 180 may have the first shape when the temperature of the shape-variable part 180 is 50° C. and the second shape when the temperature of the shape-variable part 180 is 70° C.

The shape-variable part 180 may deform in response to a variation of a first physical quantity, independent of a variation of a second physical quantity. For example, the shape-variable part 180 may deform according to variations of the amount of a current flowing therethrough, but the shape of the shape-variable part 180 may not vary even though the temperature of the shape-variable part 180 is varied.

The adjusting unit 190 may vary a physical quantity applied to the shape-variable part 180. In FIG. 6, the adjusting unit 190 is disposed on the connection part 110. However, exemplary embodiments of the present invention are not limited thereto. For example, a plurality of adjusting units 190 may be disposed close to (e.g., near) positions at which convex or concave regions are formed on the shape-variable part 180.

As described above, according to the one or more of the above exemplary embodiments, the viewing angle of the display apparatus may be adjusted.

In addition, the brightness of the display apparatus may be adjusted.

In embodiments of the present invention, an element referred to with the definite article or a demonstrative pronoun may be construed as the element or the elements even though it has a singular form. Unless otherwise defined, the ranges defined herein are intended to include any embodiment to which values within the range are individually applied and may be considered to be the same as individual values constituting the ranges in the detailed description of exemplary embodiments of the present invention.

Operations constituting a method of an exemplary embodiment of the present invention may be performed in any suitable order unless explicitly described in terms of order or described to the contrary. That is, operations are not limited to the order in which the operations are described. In embodiments of the present invention, examples or exemplary terms (for example, “such as” and “etc.”) are used for the purpose of description and are not intended to limit the scope of the exemplary embodiments unless defined by the claims. Also, those skilled in the art will readily appreciate that many alternations, combinations, and modifications may be made according to design conditions and factors within the scope of the appended claims and their equivalents.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present invention as defined by the following claims and their equivalents.

What is claimed is:

1. A display apparatus comprising:
a display unit comprising a plurality of pixels;
a connection part on the display unit;
a plurality of shape-variable parts on the connection part and configured to deform according to a physical quantity applied thereto; and
a plurality of adjustors configured to vary the physical quantity applied to the shape-variable parts to control an amount by which the shape variable parts refract light emitted from the pixels.

2. The display apparatus of claim 1, wherein the shape-variable parts are on the connection part at positions corresponding to positions of the pixels.

3. The display apparatus of claim 1, wherein each of the shape-variable parts is configured to deform to be flat, convex, or concave according to a value of the physical quantity.

4. The display apparatus of claim 3, wherein, when the shape-variable parts are convex, the light emitted from the pixels converges while passing through the shape-variable parts.

5. The display apparatus of claim 3, wherein, when the shape-variable parts are concave, the light emitted from the pixels diverges while passing through the shape-variable parts.

6. The display apparatus of claim 1, wherein the adjustors comprise temperature adjustors configured to adjust temperatures of the shape-variable parts to deform the shape-variable parts.

7. The display apparatus of claim 6, wherein the temperature adjustors each comprise:
a heating element configured to apply heat to the shape-variable parts or to the connection part; and
a current supply coupled to the heating elements and configured to supply current to each of the heating elements.

8. The display apparatus of claim 1, wherein each of the shape-variable parts comprises a conductor, and
the adjustors comprise current adjustors configured to control an amount of current flowing through the conductors of the shape-variable parts.

9. The display apparatus of claim 8, wherein each of the shape-variable parts comprises two electrodes, and
in each of the shape-variable parts, the current adjustor is configured to control an electric potential between the two electrodes to adjust an amount of current flowing through the conductor between the two electrodes.

10. The display apparatus of claim 8, wherein each of the conductors comprises carbon nanotubes.

11. The display apparatus of claim 1, further comprising:
a controller configured to output control signals and image data;
a gate driver configured to output a scan signal based on the control signals; and
a source driver configured to output a data signal based on the image data in synchronization with the scan signal,
wherein the display unit is configured to output the data signal to the pixels in synchronization with the scan signal.

12. A display apparatus comprising:
a display unit comprising a plurality of pixels;
a shape-variable part on the display unit and configured to deform according to a physical quantity applied thereto; and
an adjustor configured to vary the physical quantity applied to the shape-variable part to control an amount by which the shape-variable part refracts light emitted from the pixels.

13. The display apparatus of claim 12, wherein a plurality of convex regions and/or a plurality of concave regions are formed on a surface of the shape-variable part according to values of the physical quantity.

14. The display apparatus of claim 13, wherein the convex regions and/or the concave regions are formed at positions corresponding to positions of the pixels.

15. The display apparatus of claim 13, wherein the light emitted from the pixels converges while passing through the convex regions or diverges while passing through the concave regions.

16. The display apparatus of claim 12, wherein the adjustor comprises a temperature adjustor configured to adjust a temperature of the shape-variable part to change a shape of the shape-variable part.

17. The display apparatus of claim 16, wherein the temperature adjustor comprises:
a heating element configured to apply heat to the shape-variable part; and
a current supply coupled to the heating element and configured to supply current to the heating element.

18. The display apparatus of claim 12, wherein the shape-variable part comprises a conductor, and
the adjustor comprises a current adjustor configured to control an amount of current flowing through the conductor of the shape-variable part.

19. The display apparatus of claim 18, wherein the shape-variable part comprises first and second electrodes,
the current adjustor is configured to control an electric potential between the first and second electrodes to adjust an amount of current flowing through the conductor between the first and second electrodes, and
the conductor comprises carbon nanotubes.

20. The display apparatus of claim 12, further comprising:
a controller configured to output control signals and image data;
a gate driver configured to output a scan signal based on the control signals; and
a source driver configured to output a data signal based on the image data in synchronization with the scan signal,
wherein the display unit is configured to output the data signal to the pixels in synchronization with the scan signal.
